(19) United States
(12) Patent Application Publication
(10) Pub. No.: US 2014/0201578 A1
(43) Pub. Date: Jul. 17, 2014

(54) MULTI-TIER WATCHDOG TIMER

(71) Applicant: APPLE INC., Cupertino, CA (US)

(72) Inventors: Alexei E. Kosut, Cupertino, CA (US); Erik P. Machnicki, San Jose, CA (US)

(73) Assignee: APPLE INC., Cupertino, CA (US)

(21) Appl. No.: 13/739,554

(22) Filed: Jan. 11, 2013

(51) Int. Cl. G06F 11/07

(52) U.S. Cl. CPC G06F 11/0757
USPC 714/55

(57) ABSTRACT

Due to software bugs, hardware bugs, power fluctuations, cosmic rays, and various other causes, computing systems may from time to time enter various types of error states. This disclosure relates generally to the field of watchdog timers configured to take corrective action when a computing system enters such an error state. In various embodiments, this disclosure provides systems, methods, apparatuses, and computer-readable media for multi-tier watchdog timers. Such multi-tier watchdog timers may be configured to take different levels of corrective action at different times and/or under different conditions.

### BACKGROUND

1. Technical Field

This disclosure relates generally to the field of timers (e.g. watchdog timers) configured to take corrective action when a computing system enters an error state. More particularly, this disclosure relates to the use of multi-tier watchdog timers configured to take different levels of corrective action.

2. Description of the Related Art

Due to software bugs, hardware bugs, power fluctuations, cosmic rays, and various other causes, computing systems may from time to time enter various types of error states (e.g. hangs, kernel panics, blue screens, segmentation faults, etc.) In some circumstances, it may be desirable to use a watchdog timer to provide a failsafe, allowing such computing systems to be extricated from these error states. Watchdog timers in some embodiments may be hardware- or software-based timers configured to trigger a system reset or other corrective action if the computing device or a program running thereon (e.g., the operating system) becomes non-responsive.

Typically, a watchdog timer may be configured to measure a specified interval of time; if the timer reaches the end of this specified time interval without being restarted (e.g., the timer expires), corrective action may be triggered. Corrective action may in some embodiments include such things as resetting the computing device, resetting a portion of the computing device, resetting a processor in the computing device, triggering an interrupt (e.g., a non-maskable interrupt), etc.

During normal operation, the computing device or a program running thereon will typically, from time to time, restart the watchdog timer to prevent the corrective action from being taken. This is because during normal operation, such corrective action is typically not desirable due to the interruption it may cause. If the watchdog timer is not restarted before the expiration of the specified time interval, this is typically due to the fact that the computing device has entered an error state, and that corrective action is desirable. The watchdog timer may then act to eliminate the error state in a variety of ways, some of which are as discussed above.

What is meant by “normal operation” for purposes of this disclosure is that the computing device is not in an error state.

Various techniques for implementing watchdog timers have been used and are known in the art. In some embodiments, however, the known techniques may suffer from various drawbacks.

For example, a watchdog timer configured to trigger a total system reset may have the advantage that it is typically able to bring the system back into an operating state; however, this may be at the cost of being unable to retain debugging and/or error information. This is because, for example, in a total system reset, the contents of any volatile memory storage will typically be lost.

A watchdog timer that triggers a more limited action, such as a processor reset, may suffer from a different problem. In a system where the watchdog timer only restarts a processor, it may be possible in some embodiments to retain some debugging information (e.g., because volatile memory storage need not be reset), but the system may be less likely to return to an operating condition. This is due to the fact that, in some circumstances, more drastic action than a processor reset may be required to return the system to an operating state. For example, if the contents of memory have been corrupted or if the processor's operating voltage has been set to an incorrect value, then a processor reset may not always return the system to an operating state.

### SUMMARY

The present disclosure provides methods, systems, and apparatuses for implementing watchdog timers. In various embodiments, the present disclosure provides a multi-tier (e.g., a two-tier) watchdog timer.

In one embodiment, this disclosure includes an integrated circuit including a first timer and a second timer. In this embodiment, the first timer may be configured to signal a reset of the integrated circuit, including a restart of the first timer. The second timer may be configured to signal a reset of a device including the integrated circuit, including a restart of the first timer and a restart of the second timer.

According to another embodiment, this disclosure provides a mobile device including an integrated circuit, with the integrated circuit including a first watchdog timer and a second watchdog timer. In this embodiment, the first watchdog timer may be configured to reset a portion of the mobile device responsive to the first watchdog timer expiring, with the reset of the portion of the mobile device including a restart of the first watchdog timer. In this embodiment, the second watchdog timer may be configured to reset the mobile device responsive to the second watchdog timer expiring, with the reset of the mobile device including a restart of the first watchdog timer and a restart of the second watchdog timer.

According to a third embodiment, this disclosure provides a method usable in a computing device having a processor, where the processor includes a first watchdog timer and a second watchdog timer. The method according to this embodiment includes receiving an indication that the first watchdog timer has expired and, responsive to the indication that the first watchdog timer has expired, triggering a reset of the processor, with the reset of the processor including a restart of the first watchdog timer. The method according to this embodiment further includes receiving an indication that the second watchdog timer has expired and, responsive to the indication that the second watchdog timer has expired, triggering a reset of the computing device, with the reset of the computing device including a restart of the first watchdog timer and a restart of the second watchdog timer.

According to a fourth embodiment, this disclosure provides a system including an integrated circuit, with the integrated circuit including a first watchdog timer and a second watchdog timer. In this embodiment, the first watchdog timer may be configured to signal, responsive to the first watchdog timer expiring, a reset of a portion of the integrated circuit including the first watchdog timer and not including the second watchdog timer. Further, the second watchdog timer may be configured to signal, responsive to the second watchdog timer expiring, a reset of the system.

According to a fifth embodiment, this disclosure provides a non-transitory computer-readable storage medium having instructions coded thereon, which, when executed by a computing device including an integrated circuit implementing first and second watchdog timers, cause the computing device to perform a series of operations. The operations according to this embodiment include receiving information regarding an operating state of the computing device. When the computing device is in a normal operating state, the operations include restarting first and second watchdog timers in a processor of the computing device; and when the computing device is not in a normal operating state, the operations include not restarting the first and second watchdog timers. The operations according to this embodiment further include, responsive to an expiration of the first watchdog timer, triggering a reset of the processor, with the reset of the processor including a restart of the first watchdog timer. The operations further include, responsive to an expiration of the second watchdog timer, triggering a reset of the computing device, with the reset of the computing device including a restart of the first watchdog timer and the second watchdog timer.

One of ordinary skill in the art will understand that the above exemplary embodiments are only particular illustrations of possible implementations of the disclosed subject matter, and that various other embodiments are within the scope of the attached claims.

### BRIEF DESCRIPTION OF THE DRAWINGS

FIG. 1 is a block diagram of a system including an integrated circuit with a two-tier watchdog;

FIG. 2 is a detailed block diagram of the integrated circuit including the two-tier watchdog of FIG. 1; and

FIGS. 3-5 are process flows for using timers according to the present disclosure.

### DETAILED DESCRIPTION

### Terminology

The following paragraphs provide definitions and/or context for terms found in this disclosure (including the appended claims):

“Based On.” As used herein, this term is used to describe one or more factors that affect a determination. This term does not foreclose additional factors that may affect a determination. That is, a determination may be solely based on those factors or based only in part on those factors. Consider the phrase “determine A based on B.” This phrase connotes that B is a factor that affects the determination of A, but does not foreclose the determination of A from also being based on C. In other instances, A may be determined based solely on B.

“Comprising.” This term is open-ended. As used in the appended claims, this term does not foreclose additional structure or steps. For example, consider a claim that recites: “An apparatus comprising one or more processor units . . . .” Such a claim does not foreclose the apparatus from including additional components (e.g., a network interface unit, graphics circuitry, etc.).

“Configured To.” As used herein, this term means that a particular piece of hardware or software is arranged to perform a particular task or tasks when operated. Thus, a system that is “configured to” perform task A means that the system may include hardware and/or software that, during operation of the system, performs or can be used to perform task A. (As such, a system can be “configured to” perform task A even if the system is not currently operating.)

“Coupled.” As used herein, this term includes a connection between components, whether direct or indirect.

“Embodiment.” This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“First,” “Second,” etc. As used herein, these terms are used as labels for nouns that they precede, and do not imply any type of ordering (e.g., spatial, temporal, logical, etc.).

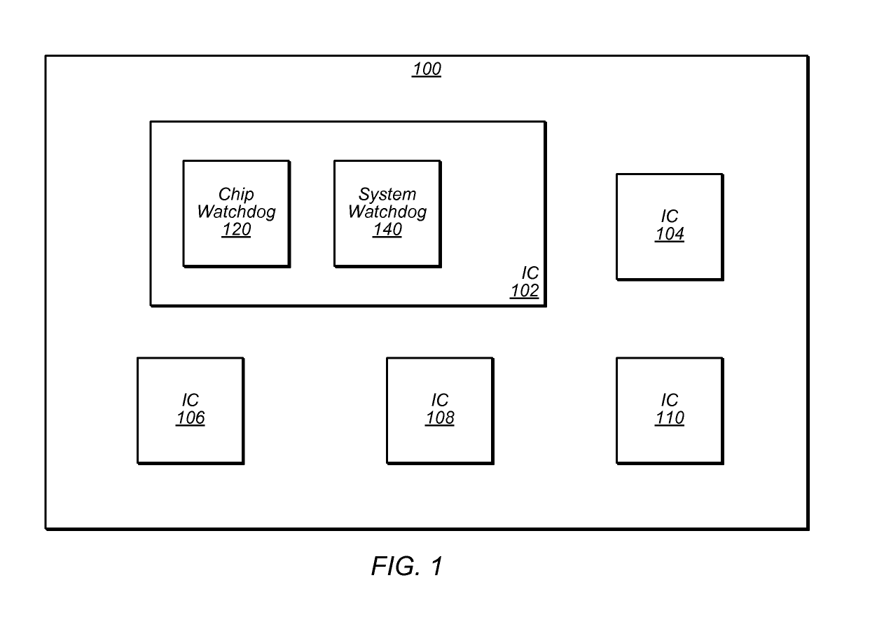

Turning now to FIG. 1, a high-level block diagram of one embodiment of the present disclosure is shown. FIG. 1 depicts device 100, which includes ICs 102, 104, 106, 108, and 110. As shown, IC 102 includes two watchdog timers: chip watchdog 120 and system watchdog 140.

ICs 102, 104, 106, 108, and 110 may broadly represent any chips, circuits, units, or other structures that might be included in an electronic device such as device 100. For example, in some embodiments they may include processors, systems-on-a-chip (SoCs), RAM or other volatile storage, non-volatile storage, power management units, network interfaces, graphics processors, sound processors, or any other suitable structures. In one embodiment, chip watchdog 120 and system watchdog 140 shown in IC 102 may advantageously be included in a processor or SoC.

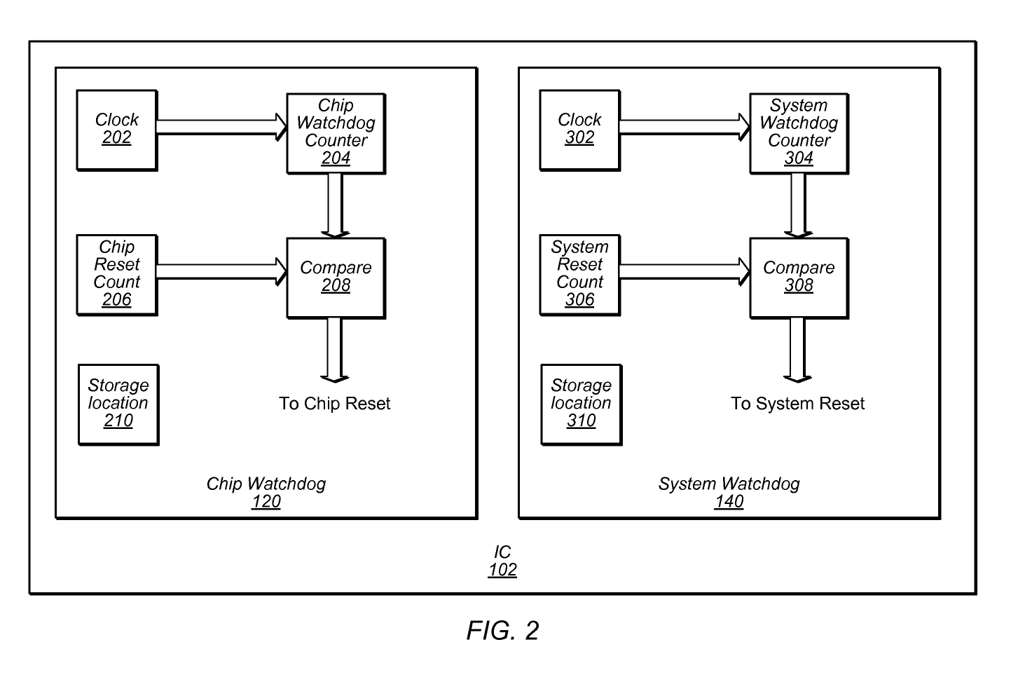

Turning now to FIG. 2, a detailed view of IC 102 is shown, which includes a depiction of how chip watchdog 120 and system watchdog 140 may be implemented in one embodiment. Chip watchdog 120 includes clock 202, chip watchdog counter 204, chip reset count 206, compare 208, and storage location 210. System watchdog 140 includes corresponding elements clock 302, system watchdog counter 304, system reset count 306, compare 308, and storage location 310. One of ordinary skill will recognize that in some embodiments, some components may be shared between chip watchdog 120 and system watchdog 140. For example, clock 202 and clock 302 may be implemented as a single clock in some embodiments, and storage location 210 and storage location 310 may be implemented as a single element in some embodiments.

These various components are shown coupled by arrows that generally represent a flow of information in a particular direction, although in some embodiments information may flow in both directions. The arrows may represent any suitable physical, electrical, optical, or other connections among the various components shown.

In one embodiment, clock 202 is coupled to chip watchdog counter 204, which counts up from zero to keep track of how many clock pulses have elapsed since chip watchdog counter 204 was last restarted. One of ordinary skill in the art will recognize that chip watchdog counter 204 could also count downward from a specified value, instead of counting upward from zero. Such an embodiment, with corresponding changes in the other components of chip watchdog 120, is also to be understood as within the scope of this disclosure. For the remainder of this discussion, however, it will be assumed that chip watchdog counter 204 counts upward from zero.

Chip reset count 206 may in various embodiments be programmed via hardware or software with a value corresponding to a desired number of clock pulses, which corresponds to the length of time desired before chip watchdog 120 acts to reset IC 102.

It is to be noted that, during normal operation of device 100, chip watchdog counter 204 will typically be restarted at zero from time to time. This can be accomplished in a variety of known ways; for example, in some embodiments, an operating system running on device 100 may periodically restart chip watchdog counter 204. It is typically only when device 100 is in an error state that chip watchdog counter 204 will fail to be restarted for a relatively long period of time. In such a situation, a chip reset may be a desirable consequence, because it may be possible to return device 100 to a normal operating state via such a chip reset.

In this embodiment, as chip watchdog counter 204 counts upward, it also outputs its current value to compare 208, which is configured to determine whether or not a chip reset is needed (for example, to correct an error condition in device 100). Compare 208 may be implemented in any of a variety of known ways. For example, compare 208 may output a TRUE value whenever the value of chip watchdog counter 204 is equal to the value of chip reset count 206, and it may output a FALSE value otherwise. In other embodiments, compare 208 may output a TRUE value whenever the value of chip watchdog counter 204 is greater than or equal to the value of chip reset count 206, and it may output a FALSE value when the value of chip watchdog counter 204 is less than the value of chip reset count 206.

When compare 208 indicates that chip watchdog counter 204 has expired (e.g. that it has reached a value corresponding to the length of time specified by chip reset count 206), compare 208 triggers a chip reset. Chip watchdog 120 in this embodiment further stores an indication in storage location 210 that a chip reset has occurred. This may be beneficial for purposes of determining what type of error has occurred.

System watchdog 140 in this embodiment includes components that correspond generally to the components of chip watchdog 120. For example, in this embodiment, clock 302 is coupled to system watchdog counter 304, which counts up from zero to keep track of how many clock pulses have elapsed since system watchdog counter 304 was last restarted. (As above, one of ordinary skill in the art will recognize that here, too, system watchdog counter 304 could also count downward from a specified value, instead of counting upward from zero. Again, however, it will be assumed for this discussion that system watchdog counter 304 counts upward from zero.)

System reset count 306 may in various embodiments be programmed via hardware or software with a value corresponding to a desired number of clock pulses, which corresponds to the length of time desired before system watchdog 140 acts to reset device 100. It is to be noted that here, too, during normal operation of device 100, system watchdog counter 304 will typically be restarted at zero from time to time. It is typically only when device 100 is in an error state that system watchdog counter 304 will fail to be restarted for a relatively long period of time.

Typically, system reset count 306 will be set to a value corresponding to a longer period of time than chip reset count 206. This is because, according to one embodiment, it may be desirable to attempt first to correct an error condition via the less extreme action of resetting the chip, rather than the more extreme action of resetting the entire system. It is typically only in the situation that a chip reset was unsuccessful that system watchdog counter 304 will expire, triggering a system reset. It is thus to be further noted that when chip watchdog 120 causes a chip reset, this chip reset will typically not restart system watchdog counter 304. Accordingly, if the chip reset is insufficient to return device 100 to an operating state, system watchdog 140 may in due course trigger the more extreme consequence of a system reset.

In this embodiment, as system watchdog counter 304 counts upward, it also outputs its current value to compare 308, which is configured to determine whether or not a system reset is needed (for example, because a chip reset did not return device 100 to an operating state). As above, compare 308 may be implemented in any of a variety of known ways.

When compare 308 indicates that system watchdog counter 304 has expired (e.g. that it has reached a value corresponding to the length of time specified by system reset count 306), compare 308 triggers a system reset. System watchdog 140 in this embodiment further stores an indication in storage location 310 that a system reset has occurred. This may be beneficial for purposes of determining what type of error has occurred. One of ordinary skill in the art will recognize that in various embodiments some storage locations may be reset by the chip watchdog (e.g. storage location 210), some storage locations may be reset by the system watchdog (e.g. storage location 310), and some storage locations may not be reset by either watchdog. One of ordinary skill in the art will further understand that storage locations 210 and 310 may be any suitable type of storage location. For example, scratch registers may be used in some embodiments to implement these storage locations according to the present disclosure.

As described above, system watchdog 140 may trigger a system reset in the event that a chip reset is insufficient to return device 100 to an operating state. In the event, however, that a chip reset is sufficient to bring device 100 back to an operating state, a variety of actions may be taken. One possibility is simply to proceed with normal operation. This course may be undesirable, however, because after an error event, the system may be in a partially unknown state. The contents of memory, for example, may have been corrupted or partially corrupted. Accordingly, in some embodiments, it may be desirable to trigger a system reset after the chip reset to ensure that the system has fully returned to a known-good state.

Prior to such a system reset, however, it may also be desirable to attempt to store data relating to the error. In various embodiments, such data may be referred to as a panic log, a core dump, a crash dump, an error report, etc. Typically such information will be stored to volatile storage (e.g., RAM) by the system prior to the expiration of chip watchdog 120. This use of volatile storage may be desirable because, in an error state, writing to non-volatile storage may not be sufficiently reliable. However, such use of volatile storage may have the disadvantage of the information being lost at the time of a system reset.

Accordingly, it may be desirable to transfer such crash information to non-volatile storage prior to the system reset. One method of accomplishing this is for chip watchdog 120 to store an indication, at the time of a chip reset, in storage location 210 that a chip reset has occurred. In one embodiment, chip watchdog 120 may store such an indication in storage location 210 prior to the occurrence of the chip reset, as long as such a chip reset is configured not to clear storage location 210.

After the chip reset has been completed, storage location 210 may be read to determine whether the reset was due to some error (e.g., that it was triggered by chip watchdog 120). Once such a determination has been made, the system may attempt to write the crash information to non-volatile storage. Once this has been accomplished, the system may be fully reset to ensure that it has returned to a normal operating state. Such a full reset may be triggered manually subsequent to storing the crash information in non-volatile storage, or it may be accomplished by simply allowing system watchdog 140 to expire.

As shown in the embodiment of FIG. 2, it may be desirable for chip watchdog 120 and system watchdog 140 to be implemented on a single IC. This is due in part to the fact that, if they are implemented on separate ICs, the discussion above regarding retention of crash information may become more problematic due to the necessity for inter-chip communications. Such communications may be accomplished in a variety of known ways (for example, via SPI, I²C, a serial interface, etc.), but these typically involve a relatively large amount of software overhead. Such software overhead may be unreliable and/or unavailable in exactly the situation where it is needed: that is, where the device has entered an error state. Accordingly, implementing chip watchdog 120 and system watchdog 140 on a single IC may have the benefit of increasing reliability by avoiding reliance on inter-chip communication techniques.

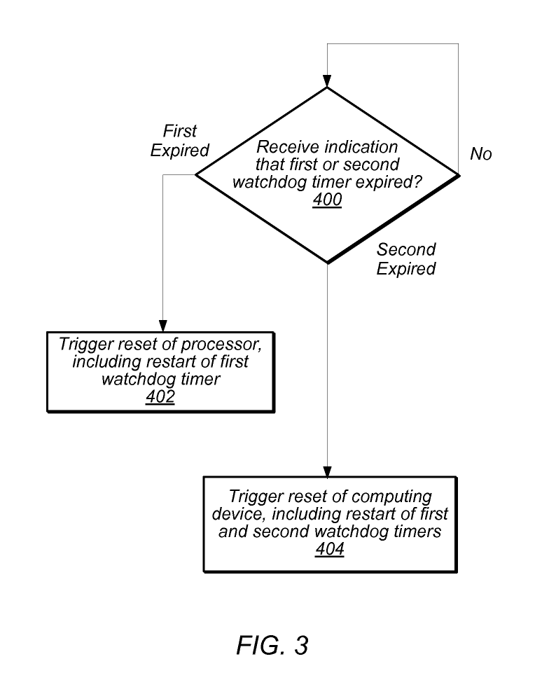

With reference to FIGS. 3-5, exemplary process flows of some embodiments of the present disclosure are provided. One of ordinary skill in the art will recognize that various modifications may be made to the specific processes shown in these figures without departing from the scope of the present disclosure.

Turning now to FIG. 3, an exemplary process flow for using the teachings of the present disclosure to provide a two-tier watchdog is shown. Although FIG. 3 describes in detail a two-tier watchdog, it is to be understood by one of ordinary skill in the art that more than two tiers could be used. FIG. 3 a process in a computing device that includes a first watchdog timer and a second watchdog timer. At step 400 in this embodiment, the computing device awaits an indication that either the first or second watchdog timer has expired. If an indication that the first watchdog timer has expired, then at step 402, the computing device triggers a reset of a processor.

This processor reset according to this embodiment includes restarting the first watchdog timer, but it does not include restarting the second watchdog timer. This is because, as described above, in the case that restarting the processor is not sufficient to return the computing device to an operating state, it may be desirable in some embodiments to allow the second watchdog timer to continue running, so that a reset of the computing device may be carried out in due course if necessary.

If, instead, the computing device receives an indication at step 400 that the second watchdog timer has expired, it will then trigger a reset of the computing device at step 404. Such a reset of the computing device includes restarting both watchdog timers in this embodiment, as discussed above.

In the embodiment of FIG. 3, if the computing device receives no indication at step 400 that either watchdog timer has expired, then it may loop back to step 400 and continue waiting.

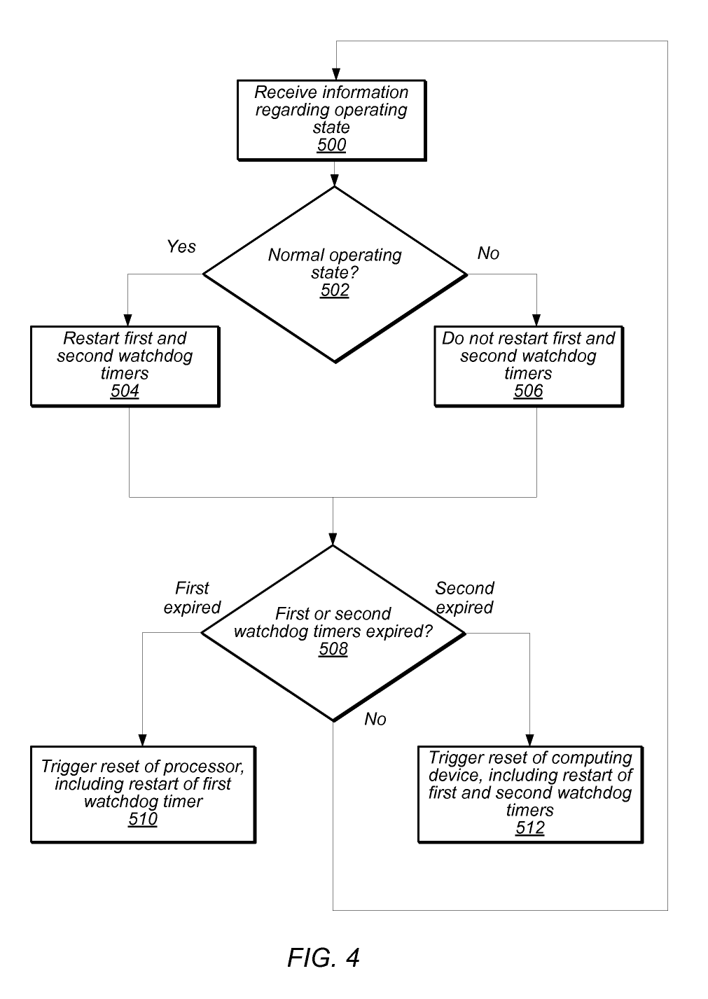

Turning now to FIG. 4, another exemplary process flow according to the present disclosure is shown. In this embodiment, a computing device at step 500 receives information regarding its operating state. At step 502, the computing device determines whether the received information indicates a normal operating state. As discussed above, this determination may indicate whether or not the computing device has encountered an error, or whether it appears to be operating properly.

In this embodiment, if the computing device is in a normal operating state, then at step 504 the first and second watchdog timers are restarted. If not, then the first and second watchdog timers are not restarted.

In either case, the computing system later makes a determination at step 508 of whether the first or second watchdog timers have expired. If neither has expired, then in this embodiment the process may loop back to step 500. If the first watchdog timer has expired, then at step 510, the computing device triggers a reset of its processor. If, on the other hand, the second watchdog timer has expired, the computing device triggers a reset of the entire computing device at step 512. In the case of a processor reset at step 510 in this embodiment, the first watchdog timer is restarted, and the second is not. In the case of a computing device reset at step 512 in this embodiment, both the first and the second watchdog timers are restarted.

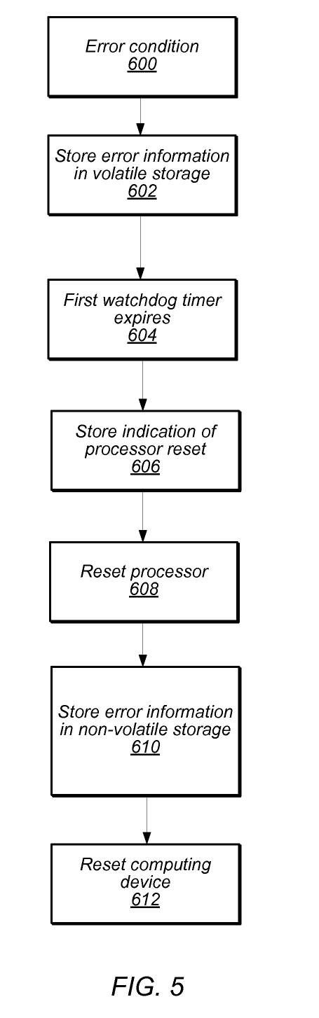

Turning now to FIG. 5, another exemplary process flow relating to the retention of error information according to the present disclosure is shown. In this embodiment, a computing device encounters an error condition at step 600. This may be any type of error; for example, a system crash, a kernel panic, etc. The computing device then stores information relating to the error in volatile storage at step 602.

At some point after the storage of the information relating to the error, the first watchdog timer expires at step 604. This may in various embodiments be because the computing system or software running thereon failed to restart the first watchdog timer for a relatively long period of time. It is to be noted that in some embodiments, the expiration of the first watchdog timer could be the event that triggers the storage of error information in volatile storage, instead of occurring afterward. Such embodiments are to be understood as within the scope of the appended claims.

The computing device then stores an indication of a processor reset at step 606. This may be accomplished in a variety of known ways; for example, it may include the storage of such information in a scratch register that is configured not to be cleared during a processor reset. After storing such an indication, the computing device resets the processor at step 608.

After the processor resets and becomes operational again, the computing device determines based on the stored indication of the processor reset that an error has occurred that required a processor reset. The system then stores crash information in non-volatile storage at step 610. This may in some embodiments be accomplished by transferring the information relating to the error stored at step 602 into non-volatile storage.

Finally, at step 612, the computing device is reset in its entirety. This clears the volatile storage, but it does not clear the non-volatile storage in this embodiment. This full system reset is typically sufficient to return the computing device to a known-good, fully operational state. The error information in non-volatile storage may later be analyzed to attempt to determine what caused the error.

The disclosed subject matter thus provides a multi-tier watchdog timer. This may improve on various aspects of known watchdog timers, such as the typical problems associated with retention of crash data when such watchdogs are triggered. Various embodiments of the present disclosure may include all, some, or none of the particular advantages described in this disclosure.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

1. An integrated circuit comprising:
a first timer configured to signal a reset of the integrated circuit responsive to the first timer expiring, wherein the reset of the integrated circuit includes a restart of the first timer; and
a second timer configured to signal a reset of a device including the integrated circuit responsive to the second timer expiring, wherein the reset of the device includes a reset of the integrated circuit, a restart of the first timer, and a restart of the second timer.

2. The integrated circuit of claim 1, wherein the first timer has a first expiration time, and wherein the second timer has a second expiration time larger than the first expiration time.

3. The integrated circuit of claim 1, further comprising at least one storage location configured to store an indication whether the first timer has expired.

4. The integrated circuit of claim 3, wherein the at least one storage location is further configured to store an indication whether the second timer has expired.

5. The integrated circuit of claim 1, wherein the integrated circuit is a system on a chip.

6. A mobile device, comprising:
an integrated circuit including:
a first watchdog timer configured to reset of a portion of the mobile device responsive to the first watchdog timer expiring, wherein the reset of the portion of the mobile device includes a restart of the first watchdog timer; and
a second watchdog timer configured to reset the mobile device responsive to the second watchdog timer expiring, wherein reset of the mobile device includes a restart of the first watchdog timer and a restart of the second watchdog timer.

7. The mobile device of claim 6, wherein the mobile device is configured to store crash information.

8. The mobile device of claim 7, wherein the mobile device is further configured to store the crash information in volatile storage.

9. The mobile device of claim 8, wherein the mobile device is configured to transfer at least a portion of the crash information to non-volatile storage subsequent to the reset of the portion of the mobile device.

10. The mobile device of claim 9, wherein the mobile device is configured to reset subsequent to the transfer.

11. A method, comprising:
in a computing device having a processor, wherein the processor includes a first watchdog timer and a second watchdog timer:
receiving an indication that the first watchdog timer has expired;
responsive to the indication that the first watchdog timer has expired, triggering a reset of the processor, wherein the reset of the processor includes a restart of the first watchdog timer;
receiving an indication that the second watchdog timer has expired; and
responsive to the indication that the second watchdog timer has expired, triggering a reset of the computing device, wherein the reset of the computing device includes a restart of the first watchdog timer and a restart of the second watchdog timer.

12. The method of claim 11, further comprising:
responsive to the expiration of the first watchdog timer and prior to the reset of the processor, storing an indication of a processor reset.

13. The method of claim 12, further comprising:
prior to the reset of the processor, storing crash information in volatile storage.

14. The method of claim 13, further comprising:
subsequent to the reset of the processor, storing at least a portion of the crash information in non-volatile storage.

15. The method of claim 14, further comprising:
subsequent to the storing the at least a portion of the crash information in non-volatile storage, triggering a reset of the computing device.

16. A system, comprising:
an integrated circuit including a first watchdog timer and a second watchdog timer;
wherein the first watchdog timer is configured to signal, responsive to the first watchdog timer expiring, a reset of a portion of the integrated circuit including the first watchdog timer and not including the second watchdog timer; and
wherein the second watchdog timer is configured to signal, responsive to the second watchdog timer expiring, a reset of the system.

17. The system of claim 16, wherein the reset of the system includes a reset of a plurality of other integrated circuits in the system.

18. The system of claim 16, wherein the system is configured to execute instructions that cause a restart of the first and second watchdog timers at specified times during normal operation.

19. The system of claim 16, wherein the integrated circuit further includes a hardware component configured to cause the restart of the first and second watchdog timers at specified times during normal operation.

20. The system of claim 16, further comprising a storage location configured to receive information regarding the expiration of the first and second watchdog timers.

21. A non-transitory computer-readable storage medium having instructions coded thereon that, when executed by a computing device, cause the computing device to perform operations comprising:
receiving information regarding an operating state of the computing device;
when the computing device is in a normal operating state, restarting first and second watchdog timers in a processor of the computing device;
when the computing device is not in a normal operating state, not restarting the first and second watchdog timers;
responsive to an expiration of the first watchdog timer, triggering a reset of the processor, wherein the reset of the processor includes a restart of the first watchdog timer; and
responsive to an expiration of the second watchdog timer, triggering a reset of the computing device, wherein the reset of the computing device includes a restart of the first watchdog timer and the second watchdog timer;
wherein the computing device includes an integrated circuit implementing the first and second watchdog timers.

22. The non-transitory computer-readable storage medium of claim 21, wherein the operations further include triggering a reset of the computing device subsequent to the reset of the processor.

23. The non-transitory computer-readable storage medium of claim 21, wherein the operations further include restarting the first and second watchdog timers periodically during normal operation of the computing device.

24. The non-transitory computer-readable storage medium of claim 21, wherein the first and second watchdog timers are implemented as hardware counters in the integrated circuit.

25. The non-transitory computer-readable storage medium of claim 24, wherein the first and second watchdog timers are configured to increment corresponding first and second storage locations in the integrated circuit, and wherein the first and second storage locations reaching corresponding first and second specified values signals the corresponding expirations of the first and second watchdog timers.
